(19) United States
(12) Patent Application Publication
(10) Pub. No.: US 2009/0249095 A1
(43) Pub. Date: Oct. 1, 2009

(54) User driven power conservation in processor-based systems

(76) Inventors: Rajesh Poornachandran, Beaverton, OR (US); Nandakishore Kushalnagar, Portland, OR (US)

Correspondence Address: TROP, PRUNER & HU, P.C., 1616 S. VOSS RD., SUITE 750, HOUSTON, TX, 77057-2631, US

(21) Appl. No.: 12/079,307

(22) Filed: Mar. 26, 2008

(51) Int. Cl. G06F 1/32

(52) U.S. Cl. 713/320

(57) ABSTRACT

A processor-based system may receive user inputs to determine how to achieve power conservation needs or preferences of the user. The user may supply inputs in terms of preferences and how power conservation might be achieved. In addition, the user may provide needs or goals for the system in terms of operating life while under battery power. The system may then develop a plan to achieve those needs and preferences and, in some embodiments, may offer that plan up to the user for approval.

### BACKGROUND

This relates generally to conservation of power in processor-based systems, such as battery based processor-based systems.

Battery based processor-based systems include laptop computers, cellular telephones, digital imaging devices, such as cameras, and global positioning devices, to mention a few examples.

Generally, battery operated processor-based system users experience, at one time or another, the situation where the available battery power is insufficient to meet the user's needs. There is generally very little that the user can do, given the situation where the available battery life is insufficient, at current consumption levels, to fulfill the user's needs or preferences.

### BRIEF DESCRIPTION OF THE DRAWINGS

FIG. 1 is a schematic depiction of one embodiment of a processor-based system;

FIG. 2 is a depiction of one power conservation technique utilized by the system of FIG. 1 in one embodiment;

FIG. 3 is a schematic depiction of another power conservation technique utilized by the system of FIG. 1 in one embodiment; and

FIG. 4 is a flow chart for a user driven power conservation scheme in accordance with one embodiment of the present invention.

### DETAILED DESCRIPTION

In accordance with some embodiments of the present invention, a user may provide input to a processor-based system to enable the processor-based system to intelligently meet the user's needs and/or preferences in terms of power conservation. In some embodiments, the user can provide two types of inputs. The first type of input, described a “user need,” is a user indication of a task that the user wishes to complete, given the available power supply resource. An example is that the user is on a plane and wants to watch a movie that is two hours in length and he wants the available power supply to meet that need. Another example is that the user wants to have a certain number of minutes of talk time on a cellular telephone and the user wants the telephone to meet that need given the remaining battery power available.

The other type of user input is a “user preference” with respect to power conservation techniques to be adopted by the processor-based system. A user preference is an indication of what power conservation tactics are most preferred by the user. For example, the user may prefer that the screen size not be reduced to save power, but the user may be perfectly happy with turning off the graphics processor and eliminating 3D graphics processing.

In accordance with some embodiments of the present invention, the user needs and/or preferences may be used by a processor-based system to adapt power conservation techniques to meet those needs and preferences. Examples of processor-based systems that are battery powered and are candidates for such techniques include laptop computers, cellular and battery powered telephones, digital imaging devices, global positioning system devices, and digital media players such as music players.

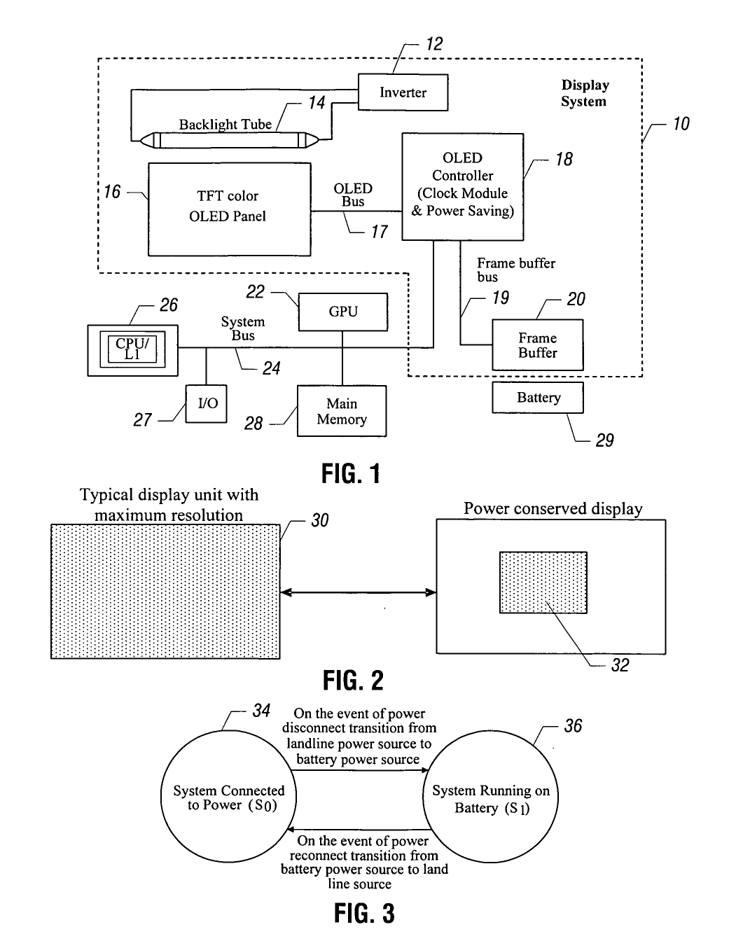

FIG. 1 shows an exemplary architecture for one such processor-based system. The system may include a display system 10. In the illustrated embodiment, the display system 10 may include an inverter 12 coupled to a back light tube 14, positioned to illuminate an organic light emitting display (OLED) panel 16. The organic light emitting display panel 16 may be coupled by a bus 17 to a display controller 18.

The display system 10 may be coupled via a system bus 24 to a processor 26, a main memory 28, and a graphics processor unit 22. A frame buffer 20 may provide storage for the controller 18 via a frame buffer bus 19 within the display system 10. An input/output device, such as a keyboard or touch screen, may be used to provide user preferences and needs. All of the components receive power from battery 29, in one embodiment. Of course, many other architectures may also be used.

Moreover, while an organic light emitting display panel 16 is illustrated, other display panels may be utilized. While in general any display panel may be utilized, in some embodiments, it may be advantageous to use a display, such as an organic light emitting display, in which the pixels may be individually controlled on and off so that the size of the actual display area may be varied to conserve power. Another example of such a display is a liquid crystal display.

Referring to FIG. 2, in an embodiment in which power conservation is achieved by changing the display area, a full size display area 30 may be transitioned to a reduced size display 32 to save power. Then, when it is no longer necessary to save power, the display may transition back to maximum size. In other embodiments, other aspects of the display, including its resolution, may be modified to conserve power.

As indicated in FIG. 3, in some embodiments, the power conservation techniques may be dependent on whether the system is connected to land line power, as indicated at 34, or running on battery, as indicated at 36. On the event of a power disconnect transition from land line power source to a battery power source, the system may transition from state 34 to state 36. Then, when land line power is restored, the system may transition from state 36 to state 34. Obviously, in state 34, the need for special power conservation techniques may be greatly reduced compared to when the system is running on battery power, as indicated in state 36.

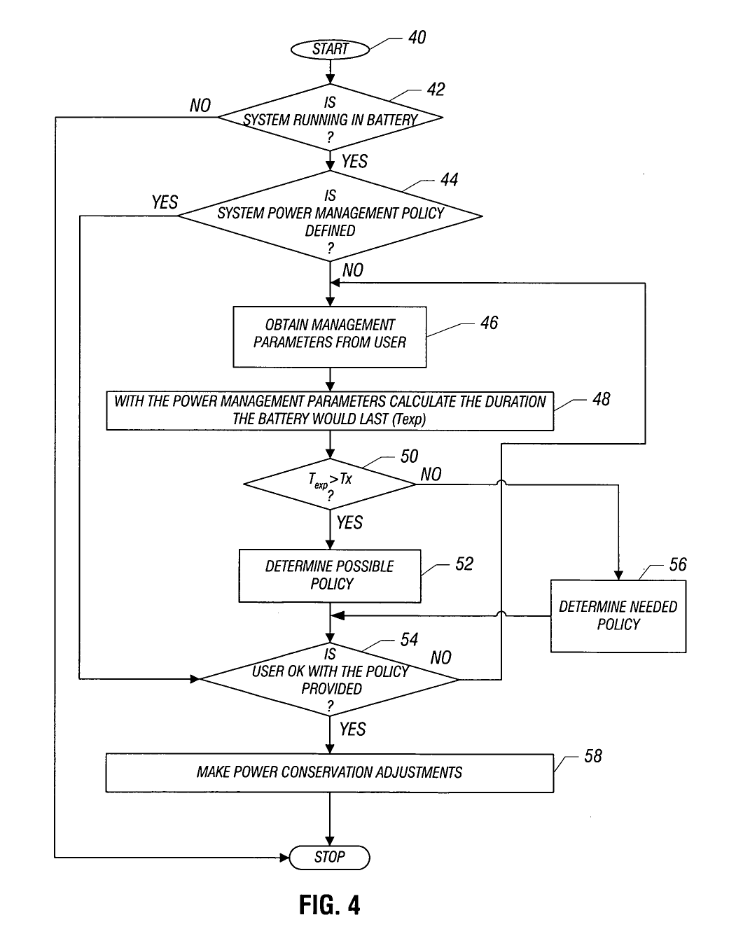

Referring to FIG. 4, a sequence 40 may include a number of steps that may be implemented by the system shown in FIG. 1 in accordance with some embodiments. In some embodiments, the sequence illustrated in FIG. 4 may be implemented by software, hardware, or microcode stored, for example, in any storage device such as the main memory 28. In the case of a software embodiment, the sequence may be executed by the processor 26. In any case, in a software or firmware embodiment, instructions may be encoded in a computer readable medium such as a semiconductor memory, an optical memory, or a magnetic memory, to mention a few examples.

In some embodiments, power conservation techniques may even be implemented by the display controller, such as the controller 18, and in software implemented embodiments, the software may be stored in a memory (not shown) coupled to the controller 18.

Continuing with FIG. 4, initially, in some embodiments, a check at diamond 42 determines whether the system is running on battery power. If not, the flow may end. Otherwise, a check at diamond 44 determines whether a system power management policy has already been defined. In some embodiments of the present invention, the user may define a plurality of power management policies for particular situations. For example, the user may define policies for when the user is doing word processing applications, when the user is doing game playing, when the user is watching DVD movies, or when the user is on an airplane, etc. In such cases, the user may select a variety of preference choices and these then may be stored and associated with an identifier, such as airplane, DVD movie, or the like. In addition, preferences may be specific to a particular user and may be stored in association with an identifier of that user.

If a system policy has already been selected, as determined in diamond 44, a check at diamond 54 determines whether the user is currently satisfied with that policy. If not, the flow returns to the sequence after diamond 44. If so, the policy's prearranged power conservation techniques may be implemented, as indicated at block 58.

If the power management policy has not been already defined, as determined in diamond 44, a policy may be defined by receiving inputs from the user at block 46. These inputs may be received, in some embodiments, by posing a series of questions to the user through graphical user interfaces. The user may be asked to indicate needs and preferences in order for the system to make intelligent decisions about how to conserve power to achieve those needs and preferences. For example, under the context of receiving user preferences, the user may be asked about whether or not the user is willing to undergo screen size reductions and may even be asked for a percentage.

Alternatively, the user may be given a sliding bar graphical user interface and may simply adjust the bar position to indicate smaller or larger active display sizes. The user may also be asked what would be an acceptable display resolution. The user may set the scale or parameter in terms of pixel resolution that is tolerable such as 1024×768 or 800×600. Alternatively, a similar bar scale graphical user interface may be utilized.

The user may also be asked for a desired display refresh rate. For example, if the user is working on a text file that does not need frequent display refreshes, the user may tolerate a lower display refresh rate. Alternatively, if the user is going to play a video game, the user may need a relatively higher refresh rate.

The user may also be asked to indicate a screen size refresh rate. This refresh rate helps the algorithm determine the time interval after which it needs to recalculate the screen size to adapt the power management settings, according to the user's usage and the system policy the user has set.

As still another example, the user may provide an input as to how much graphics processing the user needs. For example, the user could indicate how lossy a compression algorithm the user is willing to accept. The user may indicate that the graphics processor may be turned off. The user may indicate that 3D graphics processing is unneeded. Similarly, the user may indicate that it would be preferable to transition to basic graphics processing implemented by the general purpose processor 26, rather than the graphics processor unit 22. The user may transition the graphics processor unit 22 to a lower power consumption mode. Similarly, the user may indicate that certain decode engines, such as Motion Pictures Experts Group (MPEG) 4 engines, may not be needed. In addition, the user may indicate that it would be permissible to coalesce decoding tasks so that the graphics processor can simply be powered up at one time to do a plurality of decoding tasks in series, rather than handling the decoding tasks as they arrive.

In some cases, the user may be given a relatively simple graphical user interface to indicate what preferences the user has for saving power through reduced display or graphics engine capability. For example, a sliding bar graphical user interface may allow the user to indicate whether the user prefers relatively high quality graphics or whether the user is willing to move the sliding bar to allow relatively lower quality graphics. In addition, a real time estimate of the remaining battery life, assuming continued work load of the type currently undertaken, could be provided on part of the graphical user interface.

On the other hand, the system may also implement the user's goals or needs. The user may indicate a necessary battery life and the types of processing tasks that are contemplated. For example, the system may then determine on its own what the battery life will be, given the user's inputted task and battery power time. For example, the user of a cellular telephone may indicate that the user needs ten minutes of talk time. The system may then determine how to implement that need by conserving power in other ways to give the desired talk time. Thus, the user may select operating time periods that the system needs to achieve via controlling power consumption to extend battery charge lifetime. Also, the user may select specific tasks that the user wishes to utilize.

Next, in block 48 of FIG. 4, the system takes the power management parameters that were received in block 46 and calculates the duration that the battery would last given those parameters. Then, in diamond 50, the system determines whether or not the needed battery duration exceeds the available battery power. If not, a power conservation policy must be implemented, as indicated in block 56.

The power management policy takes the user's needs and preferences and selects, from among the possible power conservation techniques, those techniques that are believed to be acceptable to the user to achieve the user's needs and/or preferences. For example, in the cellular telephone context, if the user indicates that the user needs a certain talk time but, given current level of power consumption, that talk time could not be achieved, various adaptive techniques could be selected by the system, including powering down the display, blocking incoming calls, or turning off features to give the needed talk time.

In some embodiments, once a policy is implemented, a check at diamond 54 may outline that policy to the user and determine whether the user is agreeable with that policy. If so, the adjustments may be made at block 58. Otherwise, the system may go back to re-determine an acceptable policy.

In the case where the available battery power is more than sufficient to meet the user's needs and preferences, in some embodiments, a reassessment of power conservation techniques may be implemented at block 52. For example, if there is more than enough available battery power to achieve the user's needs and preferences, the user may be given an opportunity to use more power than the user's selections would indicate. For example, if the user indicated that a given screen size would be acceptable, but that screen size is unnecessarily small given the user's objectives and available battery charge, the policy may be reevaluated to provide a larger screen size that is still sufficient, given the available power of resources to meet the user's needs and preferences.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
receiving a user input in a processor-based system that includes a power conservation preference or a power conservation need; and
using the user input to develop a power conservation policy for said system that selects from among available power conservation tools, those tools that achieve the user preference or need.

2. The method of claim 1 wherein receiving a user selection of a level of graphics performance.

3. The method of claim 1 wherein receiving a user input of a power conservation need includes receiving an indication from the user of the amount of time the user needs to use the processor-based system on the available battery charge.

4. The method of claim 1 wherein using the user input includes calculating the amount of power needed to achieve the user need and comparing that amount of power to the available power from a battery.

5. The method of claim 4 wherein if the available power is more than sufficient to meet the user's needs and preferences, reassessing power conservation techniques.

6. The method of claim 1 including changing the display size to achieve a user need or preference.

7. The method of claim 1 including determining a power conservation policy and outlining said policy to the user for user approval.

8. The method of claim 1 including enabling the user to select a display resolution as a user preference.

9. The method of claim 1 including providing a real time estimate of the battery life to a user based on current work load.

10. An apparatus comprising:
a display; and
a processor-based system coupled to said display, said processor-based system to develop a power conservation policy in response to a user input of a power conservation preference or a power conservation need.

11. The apparatus of claim 10 wherein said processor-based system includes a graphics processor and said processor-based system to develop a power conservation policy in response to a user input of a user preference to alter the operation of said graphics processor.

12. The apparatus of claim 10, said processor-based system to calculate an amount of power to fulfill a user inputted need and to compare the amount of power needed to meet that need with the available power from said battery.

13. The apparatus of claim 10, said processor-based system to receive a user input and to calculate a power conservation policy to achieve said user input.

14. The apparatus of claim 13 including a processor-based system to receive a user input of a level of graphics performance and to alter the performance of a graphics processor in response thereto.

15. The apparatus of claim 13, said processor to alter the size of the display area as part of said power conservation policy.

16. The apparatus of claim 10, said processor-based system to receive a plurality of user input preferences and to determine a power conservation policy in response to those preferences.

17. The apparatus of claim 16, said processor-based system to display said power conservation policy and determine if it is acceptable to the user.
